(19) United States
(12) Patent Application Publication
(10) Pub. No.: US 2024/0234120 A1
(43) Pub. Date: Jul. 11, 2024

(54) PARTICLE SAMPLING DEVICE, AEROSOL MASS SPECTROMETER AND METHOD FOR MEASURING DIAMETER OF INDIVIDUAL PARTICLES

(71) Applicants: Yongyang Su, Xi'an (CN); Guanyi Wei, Xi'an (CN); Wei Wang, Xi'an (CN); Jiang Xu, Xi'an (CN); Zhiming Li, Xi'an (CN)

(72) Inventors: Yongyang Su, Xi'an (CN); Guanyi Wei, Xi'an (CN); Wei Wang, Xi'an (CN); Jiang Xu, Xi'an (CN); Zhiming Li, Xi'an (CN)

(21) Appl. No.: 18/476,431

(22) Filed: Sep. 28, 2023

(30) Foreign Application Priority Data
Jan. 6, 2023 (CN) 202310022206.3

(51) Int. Cl. H01J 49/04; G01N 15/10; H01J 49/24

(52) U.S. Cl. CPC H01J 49/0495; G01N 15/10; H01J 49/24; G01N 2015/1087

(57) ABSTRACT

A particle sampling device includes: a chamber having a main inlet, a main outlet, a bypass inlet and a bypass outlet, a bypass pipeline between the bypass inlet and the bypass outlet being located outside of the chamber; a gas suction pump and a gas pressure regulating valve provided on the bypass pipeline; and a gas pressure sensor and a temperature and humidity sensor for detecting parameters of aerosol flow inside the chamber. An opening degree of the gas pressure regulating valve and a rotation speed of the gas suction pump are under a feedback control of a scattering signal frequency of individual particles recorded by the aerosol mass spectrometer. A linear relationship between ln(τ) and ln(Stkₘ)^{1/2} is derived and verified experimentally, where t represents a flight time of particles, and Stkₘ represents a modified Stokes number of the corresponding particles.

### CROSS-REFERENCE TO RELATED APPLICATION

This application claims priority to and benefits of Chinese Patent Application Serial No. 202310022206.3, filed with the China National Intellectual Property Administration on Jan. 6, 2023, the entire content of which is incorporated herein by reference for all purposes.

### FIELD

The present disclosure relates to a sampling device and a measurement method for aerosol individual particles, and particularly to a particle sampling device, an aerosol mass spectrometer and a method for measuring a diameter of individual particles.

### BACKGROUND

Aerosol particle refers to a solid or liquid particle that is capable of suspending in a gas such as air. Aerosol particle size, concentration, density and composition are of great significance in many fields (environment, health, industry, etc.). Single-particle aerosol mass spectrometer (SPAMS) has been widely used for on-line monitoring and source apportionment of environmental aerosol. However, the existing devices and methods are affected by fluctuation in ambient pressure and blockage of the sampling port, resulting in an error in the measured particle diameter.

### SUMMARY

According to a first aspect of embodiments of the present disclosure, there is provided a particle sampling device, including:
a chamber having a main inlet, a main outlet, a bypass inlet and a bypass outlet, in which the main inlet is configured for entry of an ambient aerosol, the main outlet is configured to be connected to an inlet of an aerodynamic lens of an aerosol mass spectrometer, an aerosol flow channel is formed between the main inlet and the main outlet of the chamber, the bypass inlet and the bypass outlet are connected with each other via a bypass pipeline, the bypass pipeline is located outside the chamber, the bypass inlet is provided close to the main inlet, and both the bypass outlet and the bypass inlet are located on the aerosol flow channel;
a gas suction pump and a gas pressure regulating valve successively provided on the bypass pipeline between the bypass inlet and the bypass outlet; and
a gas pressure sensor and a temperature and humidity sensor, in which both a detection end of the gas pressure sensor and a detection end of the temperature and humidity sensor are connected with the chamber,
in which an opening degree of the gas pressure regulating valve and a rotation speed of the gas suction pump are under a feedback control of a scattering signal frequency of individual particles recorded by a first sizing laser and a second sizing laser of the aerosol mass spectrometer, and
a linear relationship exists between ln(τ) and ln(Stkₘ)^{1/2}, where t represents a flight time of individual particles, and Stkₘ represents a modified Stokes number of the individual particles. Stkₘ is approximated as

$${Stk}_{m} \approx \frac{( {α}_{1} + {α}_{2} )}{9} \frac{{P}_{0}}{{T}_{0}} \frac{1}{{D}_{n}} \frac{{ρ}_{p} {D}_{p}}{χ} \frac{1}{{P}_{lens}^{2}} {Z}_{0}$$

where α¹ represents a first parameter associated with a particle type, α² represents a second parameter associated with the particle type, P₀ represents standard atmospheric pressure, T₀ represents a normal temperature, Dₙ represents an inner diameter of an acceleration nozzle of the aerodynamic lens, pp represents a particle density, Dₚ represents a particle diameter, χ represents a particle shape factor, Pₗₑₙₛ represents an inlet pressure of the aerodynamic lens, and Z₀ represents a parameter associated with a carrier gas type.

According to a second aspect of embodiments of the present disclosure, there is provided an aerosol mass spectrometer, including an aerodynamic lens, and the above-mentioned particle sampling device. The main outlet of the particle sampling device is connected to an inlet of the aerodynamic lens. The first sizing laser and the second sizing laser, downstream of the acceleration nozzle of the aerodynamic lens, are provided with a preset spacing and at a direction perpendicular to an axial direction of the aerodynamic lens. The flight time t of individual particle is determined by measuring the time difference between the two scattering signals generated by the particle passing the first sizing laser and the second sizing laser.

According to a third aspect of embodiments of the present disclosure, there is provided a method for measuring a diameter of individual particles by using the above-mentioned aerosol mass spectrometer. The method includes:

S1, sampling, including:
sucking an aerosol sample into the chamber under a vacuum condition via the main inlet, and turning on the gas suction pump and the gas pressure regulating valve, such that a first part of the aerosol sample moves along the aerosol flow channel in the chamber in a direction towards the main outlet, and a second part of the aerosol sample enters the bypass pipeline, passes through the gas suction pump and the gas pressure regulating valve and returns back to the chamber via the bypass outlet to be mixed with the first part of the aerosol sample in the chamber for controllable dilution, and then a diluted aerosol sample is sucked through the main outlet into the aerodynamic lens;
continuously detecting a gas pressure in the chamber by the gas pressure sensor, and continuously detecting a temperature and a humidity in the chamber by the temperature and humidity sensor;
controlling an opening degree of the gas pressure regulating valve and a rotation speed of the gas suction pump under a feedback control of a scattering signal frequency of individual particles recorded by a first sizing laser and a second sizing laser of the aerosol mass spectrometer,
in which a linear relationship exists between ln(τ) and ln(Stkₘ)^{1/2}, where t represents a flight time of individual particles, and Stkₘ represents a modified Stokes number of the individual particles, and Stkₘ is approximated as

$${Stk}_{m} \approx \frac{( {α}_{1} + {α}_{2} )}{9} \frac{{P}_{0}}{{T}_{0}} \frac{1}{{D}_{n}} \frac{{ρ}_{p} {D}_{p}}{χ} \frac{1}{{P}_{lens}^{2}} {Z}_{0}$$

where α₁ represents a first parameter associated with a particle type, α₂ represents a second parameter associated with the particle type, P₀ represents standard atmospheric pressure, T₀ represents a normal temperature, Dₙ represents an inner diameter of an acceleration nozzle of the aerodynamic lens, pp represents a particle density, Dₚ represents a particle diameter, χ represents a particle shape factor, Pₗₑₙₛ represents an inlet pressure of the aerodynamic lens, and Z₀ represents a parameter associated with a carrier gas type; and

S2, measurement, including:
sucking aerosol particles through the main outlet of the chamber into the aerodynamic lens, and generating a particle beam by the aerodynamic lens, and measuring the flight time t of the individual particles passing between the first sizing laser and the second sizing laser.

### BRIEF DESCRIPTION OF THE DRAWINGS

FIG. 1 is a schematic diagram illustrating a particle sampling device and an aerosol mass spectrometer according to an embodiment of the present disclosure;

FIG. 2 is particle sizing calibration curves showing a linear relationship between ln(τ) and ln(Stkₘ)^{1/2} when using air or argon as a carrier gas of an aerosol sample, respectively.

### REFERENCE NUMERALS

1—main inlet, 2—main outlet, 3—chamber, 4—first filter, 5—gas suction pump, 6—gas pressure regulating valve, 7—second filter, 8—aerodynamic lens, 9—vacuum pump, 10—gas pressure sensor, 11—temperature and humidity sensor, 12—particle sampling device, 13—exhaust pipeline, 14—bypass pipeline, 15—bypass inlet, 16—bypass outlet, 17—one-way valve, 18—regulating pipeline, 19—waste gas pipeline, 20—acceleration nozzle, 21—first sizing laser, 22—second sizing laser.

### DETAILED DESCRIPTION

In order to make the objects, technical solutions and advantages of embodiments of the present disclosure clearer, technical solutions in embodiments of the present disclosure will be described below with reference to the accompanying drawings. The embodiments described in the present disclosure are only some examples, not all the possible embodiments of the present disclosure. Components in the embodiments of the present disclosure generally described and illustrated in the accompanying drawings herein may be arranged and designed in a variety of different configurations.

Aerosol particle refers to a solid or liquid particle that is capable of suspending in a gas such as air. Aerosol particle size, concentration, density and composition are of great significance in many fields (environment, health, industry, etc.). Single-particle aerosol mass spectrometer (SPAMS) has been widely used for on-line monitoring and source apportionment of environmental aerosol. In the art, an aerodynamic lens is proposed to generate a particle beam with narrow dispersion for subsequent sizing and chemical analysis. Because of the pressure drop along the aerodynamic lens, the air flow accelerates at the acceleration nozzle of the aerodynamic lens, driving the carried particles to speed up. Due to inertia, the particle flies slower than the carrier gas, and a larger, heavier particle acquires a smaller velocity. The flight time of an individual particle passing between two adjacent lasers with a known spacing is actually dependent on the particle size. The particle diameter is usually measured as follows: (1) under a given sampling condition, the flight time (τ) of individual particle with known composition, density (ρₚ) and physical diameter (Dₚ) is measured. The vacuum aerodynamic diameter (Dᵥₐ) of the corresponding particle is calculated theoretically. Then, a particle sizing calibration curve (τ-Dᵥₐ) is fitted to obtain an empirical formula; (2) under the same or similar sampling condition, the flight time of unknown individual particle is measured. Using the fitted empirical formula, the vacuum aerodynamic diameter of the particle is calculated.

The existing method for particle size measurement has the following limitations.

(1) Availability of certified standard particle or monodisperse particle for calibration. To obtain the particle sizing calibration curve using the existing method, standard or monodisperse particles with known diameter are required. However, the specification of standard particle is usually limited, while preparation of monodisperse particle is laborious and time-consuming. Hence, the number of data points and the applicable size range in the calibration curve is limited, which has adverse effect on accurate measurement of particle diameter.

(2) Influence of ambient pressure. The particle sizing calibration curve is found to be very sensitive to the inlet pressure of the aerodynamic lens, which is mainly dependent on the ambient pressure and the sampling port diameter. The ambient pressure at high altitude (e.g. at mountain top or airborne) is significantly lower than that on the ground. When sampling at airborne or in an enclosed environment, the ambient pressure would change continuously. On-site calibration is usually complicated and inconvenient. If using the calibration curve determined on the ground throughout all applications, a large error in the determined value of particle diameter would be introduced.

(3) Disturbance of sampling port blockage. The diameter of the sampling port and the acceleration nozzle in the current design of aerodynamic lens are usually at levels of sub-millimeter and millimeter, respectively. When sampling particles with high concentration for a long time, the acceleration nozzle especially the sampling port would get blocked due to particle deposition and accumulation. Accordingly, decreases in the sampling gas flow rate and the inlet pressure would occur, resulting in a shift of the particle sizing calibration curve.

To overcome the adverse effects introduced by ambient pressure fluctuation or variation, improvements in both hardware and software have been reported by previous researchers. These existing methods aim to stabilize the inlet pressure of the aerodynamic lens. When the ambient pressure fluctuates or the sampling port is blocked, the inlet pressure would deviate from the expected value. If the particle sizing calibration curve is improperly used, an error in the determined value of particle diameter will be introduced.

Embodiments of the present disclosure seek to solve at least one of the problems existing in the related art to at least some extent.

According to a first aspect of embodiments of the present disclosure, there is provided a particle sampling device, including:
a chamber having a main inlet, a main outlet, a bypass inlet and a bypass outlet, in which the main inlet is configured for entry of ambient aerosol, the main outlet is configured to be connected to an inlet of an aerodynamic lens of an aerosol mass spectrometer, an aerosol flow channel is formed between the main inlet and the main outlet of the chamber, the bypass inlet and the bypass outlet are connected with each other via a bypass pipeline, the bypass pipeline is located outside the chamber, the bypass inlet is provided close to the main inlet, and both the bypass outlet and the bypass inlet are located on the aerosol flow channel;
a gas suction pump and a gas pressure regulating valve successively provided on the bypass pipeline between the bypass inlet and the bypass outlet; and
a gas pressure sensor and a temperature and humidity sensor, in which both a detection end of the gas pressure sensor and a detection end of the temperature and humidity sensor are connected with the chamber,
in which an opening degree of the gas pressure regulating valve and a rotation speed of the gas suction pump are under a feedback control of a scattering signal frequency of individual particles recorded by a first sizing laser and a second sizing laser of the aerosol mass spectrometer, and
a linear relationship exists between ln(τ) and ln(Stkₘ)^{1/2}, where t represents a flight time of individual particles, and Stkₘ represents a modified Stokes number of the individual particles, and Stkₘ is approximated as:

$${Stk}_{m} \approx \frac{( {α}_{1} + {α}_{2} )}{9} \frac{{P}_{0}}{{T}_{0}} \frac{1}{{D}_{n}} \frac{{ρ}_{p} {D}_{p}}{χ} \frac{1}{{P}_{lens}^{2}} {Z}_{0}$$

where α¹ represents a first parameter associated with a particle type, α² represents a second parameter associated with the particle type, P₀ represents standard atmospheric pressure, T₀ represents a normal temperature, Dₙ represents an inner diameter of an acceleration nozzle of the aerodynamic lens, ρₚ represents a particle density, Dₚ represents a particle diameter, χ represents a particle shape factor, Pₗₑₙₛ represents an inlet pressure of the aerodynamic lens, and Z₀ represents a parameter associated with a carrier gas type.

In some embodiments, the particle sampling device further includes an exhaust pipeline and a one-way valve. One end of the exhaust pipeline is exposed to external environment, the other end of the exhaust pipeline is connected with the bypass pipeline, and the one-way valve is provided between the exhaust pipeline and the bypass pipeline.

In some embodiments, the one-way valve is communicated with the gas pressure sensor and is configured to be open in a case that a reading value of the gas pressure sensor exceeds a preset value.

In some embodiments, the other end of the exhaust pipeline is divided into a regulating pipeline and a waste gas pipeline; the one-way valve is provided on the regulating pipeline; and the waste gas pipeline is connected downstream of a vacuum pump located on a waste gas pipeline of the aerosol mass spectrometer.

In some embodiments, the particle sampling device further includes: a first filter provided between the bypass inlet and the gas suction pump, and a second filter provided between the gas pressure regulating valve and the bypass outlet.

In some embodiments, the chamber is cylindrical, the main inlet is located at one end of the chamber and the main outlet is located at the other end of the chamber, both the bypass inlet and the bypass outlet are located at a side wall of the chamber, and the aerosol flow channel is provided along an axial direction of the chamber.

According to a second aspect of embodiments of the present disclosure, there is provided an aerosol mass spectrometer, including an aerodynamic lens, and the above-mentioned particle sampling device. The main outlet of the particle sampling device is connected to an inlet of the aerodynamic lens. The first sizing laser and the second sizing laser, downstream of the acceleration nozzle of the aerodynamic lens, are provided with a preset spacing and at a direction perpendicular to an axial direction of the aerodynamic lens. The flight time t of individual particle passing between the first sizing laser and the second sizing laser is recorded.

According to a third aspect of embodiments of the present disclosure, there is provided a method for measuring a diameter of individual particles by using the above-mentioned aerosol mass spectrometer. The method includes:

S1, sampling, including:
sucking an aerosol sample into the chamber under a vacuum condition via the main inlet, and turning on the gas suction pump and the gas pressure regulating valve, such that a first part of the aerosol sample moves along the aerosol flow channel in the chamber in a direction towards the main outlet, and a second part of the aerosol sample enters the bypass pipeline, passes through the gas suction pump and the gas pressure regulating valve and returns back to the chamber via the bypass outlet to be mixed with the first part of the aerosol sample in the chamber for controllable dilution, and then the diluted aerosol sample is sucked into the aerodynamic lens via the main outlet;
continuously detecting a gas pressure in the chamber by the gas pressure sensor, and continuously detecting a temperature and a humidity in the chamber by the temperature and humidity sensor;
controlling an opening degree of the gas pressure regulating valve and a rotation speed of the gas suction pump under a feedback control of a scattering signal frequency of individual particles recorded by a first sizing laser and a second sizing laser of the aerosol mass spectrometer, in which a linear relationship exists between ln(τ) and ln(Stkₘ)^{1/2}, where t represents a flight time of individual particles, and Stkₘ represents a modified Stokes number of the individual particles, and Stkₘ is approximated as

$${Stk}_{m} \approx \frac{( {α}_{1} + {α}_{2} )}{9} \frac{{P}_{0}}{{T}_{0}} \frac{1}{{D}_{n}} \frac{{ρ}_{p} {D}_{p}}{χ} \frac{1}{{P}_{lens}^{2}} {Z}_{0}$$

where α₁ represents a first parameter associated with a particle type, α₂ represents a second parameter associated with the particle type, P₀ represents standard atmospheric pressure, T₀ represents a normal temperature, Dₙ represents an inner diameter of an acceleration nozzle of the aerodynamic lens, pp represents a particle density, Dₚ represents a particle diameter, χ represents a particle shape factor, Pₗₑₙₛ represents an inlet pressure of the aerodynamic lens, and Z₀ represents a parameter associated with a carrier gas type; and

S2, measurement, including:
sucking aerosol particles via the main outlet of the chamber into the aerodynamic lens, and generating a particle beam by the aerodynamic lens, and measuring the flight time t of the individual particles passing between the first sizing laser and the second sizing laser.

In some embodiments, the carrier gas is air, and the aerosol in the chamber satisfies conditions:

$$ln ( τ ) = 4.83028 + 0.77637 * {ln ( {Stk}_{m} )}^{\frac{1}{2}} ;$$

$$and$$

$${Z}_{0} = 1.645 \times 1 {0}^{5} K \cdot {m}^{2} / {s}^{2} .$$

In some embodiments, the carrier gas is argon, and the aerosol in the chamber satisfies conditions:

$$ln ( τ ) = 4.89163 + 0.78343 * {ln ( {Stk}_{m} )}^{\frac{1}{2}} ;$$

$$and$$

$${Z}_{0} = 4.982 \times 1 {0}^{5} K \cdot {m}^{2} / {s}^{2} .$$

In some embodiments, the first parameter α₁ associated with the particle type and the second parameter α₂ associated with the particle type are determined as:
α₁=1.142 and α₂=0.558 in a case that an aerosol particle is a solid particle; or
α₁=1.207 and α₂=0.440 in a case that an aerosol particle is an oil particle.

Comparing with the related art, the present disclosure is advantageous as follows:
(1) In the existing method, the particle sizing calibration curve is determined by generating several types of particles with known diameters and then measuring the corresponding flight time under stable pressure condition. However, the preparation of monodisperse particle is usually time-consuming, and the availability of standard particle is limited. In the present disclosure, the calibration curve could be acquired by measuring the flight time of one type of particles with the same diameter under varying pressure conditions. Moreover, the inlet pressure can be easily regulated by varying the sampling flow rate or the sampling port size. So, the experimental procedure for calibration is greatly simplified, the number of data points and the applicable range of gas pressure are significantly expanded, and more types of carrier gas are applicable.
(2) With the particle sampling device of the present disclosure, continuous and controllable dilution of aerosol sample is achievable in the chamber, and is applicable in a wide pressure range of ambient aerosol from a negative pressure to a positive pressure. Moreover, when the inlet pressure of the aerodynamic lens changes due to a fluctuation in the ambient pressure or a blockage of the sampling port, the value of the inlet pressure monitored by the gas pressure sensor could be used to automatically correct the measured diameter of individual particle.
(3) With the particle sampling device of the present disclosure, a combination use with an external instrument is convenient, and the present method may be integrated into the instrumental software. In this way, automation, convenience and accuracy of particle size measurement can be improved.
(4) The exhaust pipeline and the one-way valve are further provided in the present disclosure to vent exhaust gas in a case that the aerosol sample pressure is higher than one atmospheric pressure.
(5) In the present disclosure, the upstream end of the exhaust pipeline is divided into the regulating pipeline and the waste gas pipeline in such a way that the exhaust gas from the sampling device is combined with the exhaust gas from the aerosol mass spectrometer, and discharged together. The present disclosure proposes a combination structure, thereby making the design compact and allowing the exhaust gas to be treated together.
(6) The bypass pipeline of the present disclosure is further provided with the first filter and the second filter which are capable of filtering the aerosol in the bypass pipeline for dilution use.
(7) In the present disclosure, the main inlet of the chamber is located at the upstream end of the chamber and the main outlet is located at the downstream end of the chamber, so the aerosol flow channel along the axial direction of the chamber facilitates the aerosol sample flow.
(8) The inventors of the present disclosure have found a linear relationship between ln(τ) and ln(Stkₘ)^{1/2}. Based on the above-mentioned aerosol mass spectrometer, the present disclosure further provides the method for measuring the diameter of individual particles, in which the opening degree of the gas pressure regulating valve and the rotation speed of the gas suction pump are adjusted based on the scattering signal frequency of individual particle recorded by the two sizing lasers in the aerosol mass spectrometer. The inlet pressure of the aerodynamic lens is allowed to vary within a certain range. It is difficult and unnecessary to keep the inlet pressure at a stable value.

Embodiments of the present disclosure will be described in detail and examples of embodiments are illustrated in the drawings.

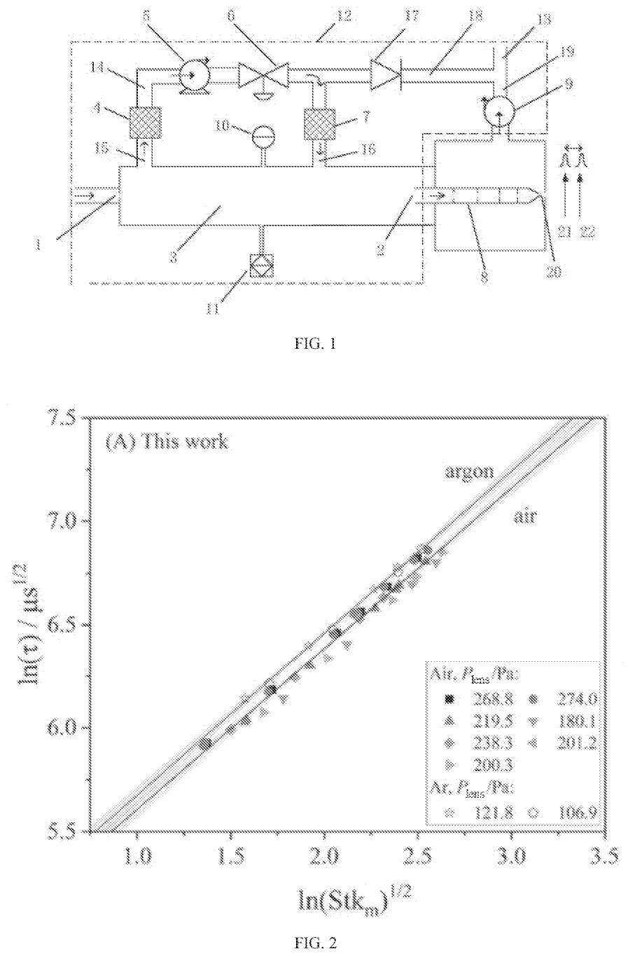

FIG. 1 is a schematic diagram illustrating a particle sampling device and an aerosol mass spectrometer according to an embodiment of the present disclosure. The aerosol mass spectrometer may be a single-particle aerosol mass spectrometer for on-line sizing and chemical analysis of aerosol individual particles, which is capable of correcting the effects of ambient pressure fluctuation and sampling port blockage on the determined diameter of individual particle.

As shown in FIG. 1, the aerosol mass spectrometer includes an aerodynamic lens 8, and a particle sampling device 12. The particle sampling device 12 includes a chamber 3, a gas pressure sensor 10 and a temperature and humidity sensor 11. The chamber 3 has a main inlet 1, a main outlet 2, a bypass inlet 15 and a bypass outlet 16. The chamber 3 is cylindrical, and the main inlet 1 is located at one end of the chamber 3, and the main outlet 2 is located at the other end of the chamber 3. The main inlet 1 is configured for entry of an aerosol sample, the main outlet 2 is connected with an inlet of an aerodynamic lens 8, and an orifice may be configured for the main inlet 1 to allow the aerosol sample with a certain flow rate to enter the chamber 3, and an aerosol flow channel (i.e., a main channel of the aerosol flow) is formed between the main inlet 1 and the main outlet 2 in the chamber 3. Both the bypass inlet 15 and the bypass outlet 16 are located on a side wall of the chamber 3. The bypass inlet 15 and the bypass outlet 16 are connected with each other via a bypass pipeline 14 in which the bypass channel of aerosol flow is formed, the bypass pipeline 14 is located outside the chamber 3, the bypass inlet 15 is provided close to the main inlet 1, and both the bypass outlet 16 and the bypass inlet 15 are located on the bypass channel.

A first filter 4, a gas suction pump 5, a gas pressure regulating valve 6 and a second filter 7 are provided in turn on the bypass pipeline 14 between the bypass inlet 15 and the bypass outlet 16. A detection end of the gas pressure sensor 10 and a detection end of the temperature and humidity sensor 11 are both connected with the chamber 3. An opening degree of the gas pressure regulating valve 6 and a rotation speed of the gas suction pump 5 are adjusted based on a scattering signal frequency of individual particles recorded by a first sizing laser 21 and a second sizing laser 22 in the aerosol mass spectrometer.

Further, an exhaust pipeline 13 and a one-way valve 17 are provided in the present disclosure, and an exhaust gas from the sampling device may be directly discharged or may be mixed with an exhaust gas from the mass spectrometer and discharged together. In a case that the exhaust gas from the sampling device is discharged directly, a downstream end of the exhaust pipeline 13 is exposed to the environment and an upstream end of the exhaust pipeline 13 is connected with the bypass pipeline 14, and the one-way valve 17 is provided between the exhaust pipeline 13 and the bypass pipeline 14. In a case that the exhaust gas from the sampling device mixes with the exhaust gas from the mass spectrometer prior to discharge (as shown in FIG. 1), the upstream end of the exhaust pipeline 13 is divided into a regulating pipeline 18 and a waste gas pipeline 19, the one-way valve 17 is provided on the regulating pipeline 18, the waste gas pipeline 19 is connected downstream of a vacuum pump 9 on the exhaust gas pipeline of the aerosol mass spectrometer, the regulating pipeline 18 is connected with the bypass pipeline 14 at a position between the gas pressure regulating valve 6 and the second filter 7.

It should be noted that the aerosol mass spectrometer has other components such as a mass analyzer, an ionization source and a data processing system, which may be arranged in integration or as separate units. Normal functions of the aerosol mass spectrometer and the components are known in the art and thus are not described in the present disclosure.

In the embodiments, there is further provided a non-transitory computer-readable storage medium including instructions that, when executed by a processor of the aerosol mass spectrometer, to perform any of the above-described methods. For example, the non-transitory computer-readable storage medium may be a ROM, a RAM, a CD-ROM, a magnetic tape, a floppy disc, an optical data storage device, and the like.

The working principle of the particle sampling device 12 in the present disclosure is as follows. The ambient aerosol is sucked into the chamber 3 via the main inlet 1, one part of the aerosol sample flows directly inside the chamber 3, and the rest part of aerosol sample enters via the bypass inlet 15 into the bypass pipeline 14. The aerosol entering into the bypass pipeline 14 is filtered by the first filter 4, and passes through the gas pressure regulating valve 6 and the second filter 7 and is sent back to the chamber 3 under drive of the gas suction pump 5. Further, the two parts of aerosol flow are mixed together in the chamber 3 at a controlled ratio of flow rate for precise dilution, and the mixed aerosol is sucked into the aerodynamic lens 8 for focusing and subsequent detection. The exhaust gas is evacuated via the vacuum pump 9. The gas pressure and the temperature and humidity of the aerosol flow inside the chamber 3 are monitored by the gas pressure sensor 10 and the temperature and humidity sensor 11, respectively. The opening degree of the gas pressure regulating valve 6 and the rotation speed of the gas suction pump 5 are under a feedback control of the scattering signal frequency of individual particle recorded by the first sizing laser 21 and the second sizing laser 22. An appropriate dilution is achieved for single particle detection and analysis, avoiding the mutual interference and particle deposition. Moreover, the gas pressure inside the chamber 3 is stabilized within a certain range. Furthermore, in a case that the gas pressure of ambient aerosol is higher than one atmospheric pressure and accordingly the inlet pressure of the aerodynamic lens 8 is greater than a preset value, the one-way valve 17 is opened and the excess gas is discharged through the regulating pipeline 18 to the exhaust pipeline 13.

During particle size measurement, with the above sampling process, the aerosol enters the inlet of the aerodynamic lens 8 through the main outlet 2 of the particle sampling device 12, and is detected individually.

Under the operating conditions of varying ambient pressure and carrier gas type, the flight times of individual particles with different sizes or types (such as polystyrene latex and silica particles) in vacuum are experimentally measured. The fitting results show that ln(τ) of the particle is linear proportional to ln(Stkₘ)^{1/2}, where t represents the flight time of individual particles and Stkₘ represents the modified Stokes number of the corresponding particle. Based on reasonable assumptions and approximations, an empirical expression of Stkₘ is derived as follows:

$${Stk}_{m} \approx \frac{( {α}_{1} + {α}_{2} )}{9} \frac{{P}_{0}}{{T}_{0}} \frac{1}{{D}_{n}} \frac{{ρ}_{p} {D}_{p}}{χ} \frac{1}{{P}_{lens}^{2}} {Z}_{0}$$

In the above formula, α₁ and α₂ are both empirical constants. For solid particles, α₁=1.142 and α₂=0.558. For oil particles, α₁=1.207 and α₂=0.440. P₀=101325 Pa, and T₀=293 K. ρₚ, Dₚ, and χ represent density, diameter and shape factor of the particles, respectively (χ=1 for spherical particles). Dₙ represents an inner diameter of an acceleration nozzle 20 of the aerodynamic lens, Pₗₑₙₛ represents an inlet pressure of the aerodynamic lens, Z₀ represents an empirical constant associated with a carrier gas type, but independent of Pₗₑₙₛ. Z₀=1.645×10⁵ K·m²/s² when the carrier gas is air. It is clear that

$$\frac{( {α}_{1} + {α}_{2} )}{9} \frac{{P}_{0}}{{T}_{0}}$$

is a constant value,

$$\frac{1}{{D}_{n}}$$

is solely determined by the inner diameter of the acceleration nozzle in the aerodynamic lens,

$$\frac{{ρ}_{p} {D}_{p}}{χ}$$

is a parameter associated with particle properties,

$$\frac{1}{{P}_{lens}^{2}}$$

is determined by the inlet pressure of the aerodynamic lens, and Z₀ is an empirical constant dependent on the type of carrier gas in the aerosol.

The gas pressure sensor 10 monitors the inlet pressure Pₗₑₙₛ of the aerodynamic lens for calculating the particle diameter. The opening degree of the gas pressure regulating valve 6 and the rotation speed of the gas suction pump 5 are adjusted under a feedback control of the scattering signal frequency of individual particles recorded by the first sizing laser 21 and the second sizing laser 22 of the aerosol mass spectrometer. In a case that the scattering signal frequency is too high, the particle concentration is too high to size the individual particles. The gas pressure sensor 10 is configured to monitor the gas pressure in the chamber 3 and the temperature and humidity sensor 11 is configured to monitor the temperature and humidity in the chamber 3. The output signals of the two sensors are imported into a controller for generating a transmit signals. The controller may be arranged separately or integrated with other elements.

In embodiments of the present disclosure, in a case that the carrier gas is air, the linear relationship between ln(τ) and ln(Stkₘ)^{1/2} is as follows:

$$ln ( τ ) = 4.83028 + 0.77637 * {ln ( {Stk}_{m} )}^{\frac{1}{2}}$$

Z₀=1.645×10⁵ K·m²/s² for air as the carrier gas. In a case that the carrier gas is argon, the linear relationship between ln(τ) and ln(Stkₘ)^{1/2} is as follows:

$$ln ( τ ) = 4.89163 + 0.78343 * {ln ( {Stk}_{m} )}^{\frac{1}{2}}$$

Z₀=4.982×10⁵ K·m²/s² for argon as the carrier gas. The fitted coefficients for argon are in agreement with those for air within an uncertainty range. As shown in FIG. 2, the linear relationship between ln(τ) and ln(Stkₘ)^{1/2} is verified through multiple sets of experiments using the aerosol mass spectrometer of the present disclosure. The linear relationship is found be independent of the inlet pressure (Pₗₑₙₛ), the particle parameters, and the type of carrier gas (e.g., air or argon).

Furthermore, using the known value of particle density (ρₚ) and assuming χ=1, the particle diameter (Dₚ) can be determined, as shown in Table 1. The relative deviations of the measured value from the nominal value are all less than 20%, and better than 10% in most cases.

TABLE 1
Comparison of measured (D_{p, m}) and nominal
(D_{p, st}) values of particle diameter

| Carrier | | Par- | ρₚ/g | | | | |
|---|---|---|---|---|---|---|---|
| gas | Pₗₑₙₛ/Pa | ticles | cm⁻³ | D_{p, st}/μm | τ/μs | D_{p, m}/μm | R.D. |
| Air | 274.0 | SiO₂ | 1.98 | 0.73 | 797.3 | 0.831 | 13.8% |
| | 274.0 | SiO₂ | 2.01 | 0.99 | 909.2 | 1.148 | 16.0% |
| | 274.0 | PSL | 1.05 | 0.203 | 374.5 | 0.224 | 10.2% |
| | 274.0 | PSL | 1.05 | 0.401 | 481.7 | 0.428 | 6.7% |
| | 274.0 | PSL | 1.05 | 0.803 | 634.3 | 0.869 | 8.3% |
| | 274.0 | PSL | 1.05 | 1.036 | 706.1 | 1.146 | 10.6% |
| | 180.1 | PSL | 1.05 | 0.203 | 465.3 | 0.169 | −16.7% |
| | 180.1 | PSL | 1.05 | 0.401 | 606.7 | 0.335 | −16.5% |
| | 180.1 | PSL | 1.05 | 0.803 | 808.1 | 0.701 | −12.7% |
| | 180.1 | PSL | 1.05 | 1.036 | 901.8 | 0.925 | −10.3% |
| | 219.5 | SiO₂ | 1.98 | 0.73 | 905.2 | 0.739 | 1.3% |
| | 219.5 | PSL | 1.05 | 0.203 | 419.2 | 0.192 | −5.4% |
| | 219.5 | PSL | 1.05 | 0.401 | 543.8 | 0.375 | −6.4% |
| | 219.5 | PSL | 1.05 | 0.803 | 721.2 | 0.777 | −3.3% |
| | 219.5 | PSL | 1.05 | 1.036 | 803.5 | 1.026 | −1.0% |
| Argon | 121.8 | PSL | 1.05 | 0.203 | 463.0 | 0.209 | 3.0% |
| | 121.8 | PSL | 1.05 | 0.401 | 598.1 | 0.402 | 0.2% |
| | 121.8 | PSL | 1.05 | 0.803 | 789.3 | 0.816 | 1.6% |
| | 121.8 | PSL | 1.05 | 1.036 | 879.9 | 1.077 | 3.9% |
| | 106.9 | PSL | 1.05 | 0.203 | 497.9 | 0.194 | −4.5% |
| | 106.9 | PSL | 1.05 | 0.401 | 648.5 | 0.381 | −5.1% |
| | 106.9 | PSL | 1.05 | 0.803 | 858.8 | 0.780 | −2.9% |
| | 106.9 | PSL | 1.05 | 1.036 | 957.6 | 1.030 | −0.6% |

The devices and methods of the present disclosure may be applied in various applications, such as automotive exhaust source characterization and environmental aerosol analysis. For example, the aerosol mass spectrometer of the present disclosure is used to detect contaminants in an urban environment. The particle sampling device is deployed on a road side unit on an urban main road. The air is sucked into the aerosol mass spectrometer which detects and analyzes tens of thousands of particles. The recorded information of the detected particles can be classified, for example, by means of a neural network algorithm, for elucidating the source and transportation of the airborne particles, and further taking relevant measures to reduce concentrations of harmful particles.

Terms used in embodiments of the present disclosure are only for the purpose of describing specific embodiments, and should not be construed to limit the present disclosure. As used in the embodiments of the present disclosure and the appended claims, “a/an”, “said” and “the” in a singular form are intended to include plural forms, unless clearly indicated in the context otherwise.

Although explanatory embodiments have been described above, it would be appreciated by those skilled in the art that changes, amendments, alternatives and modifications can be made without departing from principles and spirit of the present disclosure. The scope of the present disclosure is defined by the appended claims and the like.

What is claimed is:

1. A particle sampling device, comprising:
a chamber (3) having a main inlet (1), a main outlet (2), a bypass inlet (15) and a bypass outlet (16), wherein the main inlet (1) is configured for entry of ambient aerosol, the main outlet (2) is configured to be connected to an inlet of an aerodynamic lens (8) of an aerosol mass spectrometer, an aerosol flow channel is formed between the main inlet (1) and the main outlet (2) of the chamber (3), the bypass inlet (15) and the bypass outlet (16) are connected with each other via a bypass pipeline (14), the bypass pipeline (14) is located outside the chamber (3), the bypass inlet (15) is provided close to the main inlet (1), and both the bypass outlet (16) and the bypass inlet (15) are located on the aerosol flow channel;
a gas suction pump (5) and a gas pressure regulating valve (6) successively provided on the bypass pipeline (14) between the bypass inlet (15) and the bypass outlet (16); and
a gas pressure sensor (10) and a temperature and humidity sensor (11), wherein both a detection end of the gas pressure sensor (10) and a detection end of the temperature and humidity sensor (11) are connected with the chamber (3),
wherein an opening degree of the gas pressure regulating valve (6) and a rotation speed of the gas suction pump (5) are under a feedback control of a scattering signal frequency of individual particles recorded by a first sizing laser (21) and a second sizing laser (22) of the aerosol mass spectrometer, and
wherein a linear relationship exists between ln(τ) and ln(Stkₘ)^{1/2}, where t represents a flight time of individual particles, and Stkₘ represents a modified Stokes number of the individual particles, and Stkₘ is approximated as
$${Stk}_{m} \approx \frac{( {α}_{1} + {α}_{2} )}{9} \frac{{P}_{0}}{{T}_{0}} \frac{1}{{D}_{n}} \frac{{ρ}_{p} {D}_{p}}{χ} \frac{1}{{P}_{lens}^{2}} {Z}_{0}$$
where α₁ represents a first parameter associated with a particle type, α₂ represents a second parameter associated with the particle type, P₀ represents standard atmospheric pressure, T₀ represents a normal temperature, Dₙ represents an inner diameter of an acceleration nozzle (20) of the aerodynamic lens (8), pp represents a particle density, Dₚ represents a particle diameter, χ represents a particle shape factor, Pₗₑₙₛ represents an inlet pressure of the aerodynamic lens (8), and Z₀ represents a parameter associated with a carrier gas type.

2. The particle sampling device according to claim 1, further comprising an exhaust pipeline (13) and a one-way valve (17),
wherein one end of the exhaust pipeline (13) is exposed to external environment, the other end of the exhaust pipeline (13) is connected with the bypass pipeline (14), and the one-way valve (17) is provided between the exhaust pipeline (13) and the bypass pipeline (14).

3. The particle sampling device according to claim 2, wherein the one-way valve (17) is communicated with the gas pressure sensor (10) and is configured to be open in a case that a reading value of the gas pressure sensor (10) exceeds a preset value.

4. The particle sampling device according to claim 2, wherein the other end of the exhaust pipeline (13) is divided into a regulating pipeline (18) and a waste gas pipeline (19);
the one-way valve (17) is provided on the regulating pipeline (18); and
the waste gas pipeline (19) is connected downstream of a vacuum pump (9) located on a waste gas pipeline of the aerosol mass spectrometer.

5. The particle sampling device according to claim 1, further comprising:
a first filter (4) provided between the bypass inlet (15) and the gas suction pump (5), and
a second filter (7) provided between the gas pressure regulating valve (6) and the bypass outlet (16).

6. The particle sampling device according to claim 1, wherein the chamber (3) is cylindrical, the main inlet (1) is located at one end of the chamber (3) and the main outlet (2) is located at the other end of the chamber (3), both the bypass inlet (15) and the bypass outlet (16) are located at a side wall of the chamber (3), and the aerosol flow channel is provided along an axial direction of the chamber (3).

7. An aerosol mass spectrometer, comprising an aerodynamic lens (8), and the particle sampling device (12) according to claim 1,
wherein the main outlet (2) of the particle sampling device (12) is connected to an inlet of the aerodynamic lens (8); and
the first sizing laser (21) and the second sizing laser (22) are provided downstream of the acceleration nozzle (20) of the aerodynamic lens (8), and placed with a preset spacing and at a direction perpendicular to an axial direction of the aerodynamic lens (8) to record the flight time τ of the individual particles passing between the first sizing laser (21) and the second sizing laser (22).

8. The aerosol mass spectrometer according to claim 7, wherein the particle sampling device (12) further comprises an exhaust pipeline (13) and a one-way valve (17),
wherein one end of the exhaust pipeline (13) is exposed to external environment, the other end of the exhaust pipeline (13) is connected with the bypass pipeline (14), and the one-way valve (17) is provided between the exhaust pipeline (13) and the bypass pipeline (14).

9. The aerosol mass spectrometer according to claim 8, wherein the one-way valve (17) is communicated with the gas pressure sensor (10) and is configured to be opened in a case that a reading value of the gas pressure sensor (10) exceeds a preset value.

10. The aerosol mass spectrometer according to claim 8, wherein the other end of the exhaust pipeline (13) is divided into a regulating pipeline (18) and a waste gas pipeline (19);
the one-way valve (17) is provided on the regulating pipeline (18); and
the waste gas pipeline (19) is connected downstream of a vacuum pump (9) located on a waste gas pipeline of the aerosol mass spectrometer.

11. The aerosol mass spectrometer according to claim 7, wherein the particle sampling device (12) further comprises:
a first filter (4) provided between the bypass inlet (15) and the gas suction pump (5), and
a second filter (7) provided between the gas pressure regulating valve (6) and the bypass outlet (16).

12. The aerosol mass spectrometer according to claim 7, wherein the chamber (3) is cylindrical, the main inlet (1) is located at one end of the chamber (3) and the main outlet (2) is located at the other end of the chamber (3), both the bypass inlet (15) and the bypass outlet (16) are located at a side wall of the chamber (3), and the aerosol flow channel is provided along an axial direction of the chamber (3).

13. A method for measuring a diameter of individual particles by the aerosol mass spectrometer according to claim 7, comprising:
S1, sampling, comprising:
sucking an aerosol sample into the chamber (3) under a vacuum condition via the main inlet (1), and turning on the gas suction pump (5) and the gas pressure regulating valve (6), such that a first part of the aerosol sample moves along the aerosol flow channel in the chamber (3) in a direction towards the main outlet (2), and a second part of the aerosol sample enters into the bypass pipeline (14), passes through the gas suction pump (5) and the gas pressure regulating valve (6) and returns back to the chamber (3) via the bypass outlet (16) to be mixed with the first part of the aerosol sample in the chamber (3) for controllable dilution, and a diluted aerosol sample is sucked into the aerodynamic lens (8) via the main outlet (2);
continuously detecting a gas pressure in the chamber (3) by the gas pressure sensor (10), and continuously detecting a temperature and a humidity in the chamber (3) by the temperature and humidity sensor (11);
controlling an opening degree of the gas pressure regulating valve (6) and a rotation speed of the gas suction pump (5) under a feedback control of a scattering signal frequency of individual particles recorded by a first sizing laser (21) and a second sizing laser (22) of the aerosol mass spectrometer,
wherein a linear relationship exists between ln(τ) and ln(Stkₘ)^{1/2}, where t represents a flight time of individual particles, and Stkₘ represents a modified Stokes number of the individual particles. Stkₘ is approximated as
$${Stk}_{m} \approx \frac{( {α}_{1} + {α}_{2} )}{9} \frac{{P}_{0}}{{T}_{0}} \frac{1}{{D}_{n}} \frac{{ρ}_{p} {D}_{p}}{χ} \frac{1}{{P}_{lens}^{2}} {Z}_{0}$$
where α₁ represents a first parameter associated with a particle type, α₂ represents a second parameter associated with the particle type, P₀ standard atmospheric pressure, T₀ represents a normal temperature, Dₙ represents an inner diameter of an acceleration nozzle (20) of the aerodynamic lens (8), ρₚ represents a particle density, Dₚ represents a particle diameter, χ represents a particle shape factor, Pₗₑₙₛ represents an inlet pressure of the aerodynamic lens (8), and Z₀ represents a parameter associated with a carrier gas type; and
S2, measurement, comprising:
sucking aerosol particles through the main outlet (2) of the chamber (3) into the aerodynamic lens (8), and generating a particle beam by the aerodynamic lens (8), and measuring the flight time τ of the individual particles passing between the first sizing laser (21) and the second sizing laser (22).

14. The method according to claim 13, wherein the carrier gas is air, and the aerosol in the chamber (3) satisfies:
$$ln ( τ ) = 4.83028 + 0.77637 * {ln ( {Stk}_{m} )}^{\frac{1}{2}} ;$$
$$and$$
$${Z}_{0} = 1.645 \times 1 {0}^{5} K \cdot {m}^{2} / {s}^{2} .$$

15. The method according to claim 13, wherein the carrier gas is argon, and the aerosol in the chamber (3) satisfies:
$$ln ( τ ) = 4.89163 + 0.78343 * {ln ( {Stk}_{m} )}^{\frac{1}{2}} ;$$
$$and$$
$${Z}_{0} = 4.982 \times 1 {0}^{5} K \cdot {m}^{2} / {s}^{2} .$$

16. The method according to claim 13, wherein the first parameter an associated with the particle type and the second parameter α₂ associated with the particle type are determined as:
α₁=1.142 and α₂=0.558 in a case that an aerosol particle is a solid particle; or
α₁=1.207 and α₂=0.440 in a case that an aerosol particle is an oil particle.
